(19) United States
(12) Patent Application Publication
(10) Pub. No.: US 2026/0203412 A1
(43) Pub. Date: Jul. 16, 2026

(54) IDENTIFYING AND PRIORITIZING VULNERABILITY CHAINS IN MULTI-CLOUD ENVIRONMENTS

(71) Applicant: International Business Machines Corporation, Armonk, NY (US)

(72) Inventors: Nikki Elyse Robinson, Davidsonville, MD (US); Richard Howe, Mebane, NC (US); Kimberly Hancock, Brookfield, CT (US); Jamal Galette, Orlando, FL (US); James Travers Bray, Austin, TX (US)

(21) Appl. No.: 19/023,064

(22) Filed: Jan. 15, 2025

(51) Int. Cl. G06F 21/57; G06F 21/62

(52) U.S. Cl. CPC G06F 21/577; G06F 21/6218

(57) ABSTRACT

A computer-implemented method, system, and computer program product for identifying and prioritizing vulnerability chains in multi-cloud environments. A list of common vulnerabilities and exposures (CVEs) associated with a multi-cloud environment is received. Furthermore, vulnerability characteristics used in assessing a security vulnerability's severity are retrieved for respective CVEs in the list of CVEs. Additionally, the retrieved vulnerability characteristics are mapped with the list of CVEs associated with the multi-cloud environment to form a linked list. Such a mapping is used to identify and assess the severity of security vulnerabilities within a multi-cloud environment thereby enabling the prioritization of remediation efforts by understanding the potential impact of each vulnerability based on its characteristics. Upon identifying vulnerability chains in the multi-cloud environment from the linked list, the severity of potential maliciousness and risk of the identified vulnerability chain are assessed, such as via a priority score (e.g., X-Force threat score).

### TECHNICAL FIELD

The present disclosure relates generally to vulnerability chains, and more particularly to identifying and prioritizing vulnerability chains in multi-cloud environments.

### BACKGROUND

A vulnerability chain, also known as an exploit chain, is an attack method that combines multiple vulnerabilities to gain a greater level of compromise than a single vulnerability would allow. That is, a vulnerability chain is a combination of vulnerabilities, including low or medium rated vulnerabilities, that can create a critical attack against systems, especially when such systems are interconnected. For example, an exploitable vulnerability in one cloud environment could lead an attacker to gain access or escalate privileges across multiple cloud environments leading to massive data loss or system downtime.

Typically, cybersecurity attempts to identify and mitigate security vulnerabilities to prevent cyberattacks focus on a single cloud environment or require special connectivity between cloud accounts of multiple cloud environments which could actually increase risk across such cloud environments. For instance, the greater the interconnectivity between platforms, infrastructure, and applications, the higher the risk for attack techniques to be leveraged, such as injection attacks (inserting malicious code into a system through user input), disruption attacks (actions to overload or disable a system), or account compromise attacks (gaining access to a user's account credentials to gain unauthorized access to data or systems). For example, if a vulnerability was exploited in cloud environment A, and an attacker was able to leverage another vulnerability in cloud environment B to build a vulnerability chaining attack between the two cloud environments, they would be able to compromise two large cloud environments.

Unfortunately, there is not currently a means for effectively identifying vulnerability chains between cloud environments thereby making it impossible to remediate and prevent vulnerability attacks across cloud platforms. As a result, a significant cyber attack in a multi-cloud environment, such as a major data exfiltration (e.g., theft of sensitive data), ransomware (e.g., encrypts data and demands a ransom to decrypt it), and malware deployments (e.g., facilitates the data theft and potentially disrupts operations within the affected system), may occur. Such a significant cyber attack may result in disruption to systems impacting users and business revenue.

### SUMMARY

In one embodiment of the present disclosure, a computer-implemented method for identifying and prioritizing vulnerability chains in multi-cloud environments comprises receiving a list of common vulnerabilities and exposures (CVEs) associated with a multi-cloud environment. The method further comprises retrieving, for respective CVEs in the list of CVEs, vulnerability characteristics used in assessing a security vulnerability's severity. The method additionally comprises mapping the retrieved vulnerability characteristics with the list of CVEs associated with the multi-cloud environment to form a linked list. Furthermore, the method comprises identifying vulnerability chains in the multi-cloud environment from the linked list. Additionally, the method comprises generating priority scores for the identified vulnerability chains in the multi-cloud environment.

Furthermore, in one embodiment of the present disclosure, the vulnerability characteristics used in assessing the security vulnerability's severity comprise an asset cloud environment, an attack vector, a vulnerability threat score, a vulnerability attack complexity, and a vulnerability exploit weaponization.

Additionally, in one embodiment of the present disclosure, the method further comprises creating node objects from the mapping of the retrieved vulnerability characteristics with the list of CVEs associated with the multi-cloud environment.

Furthermore, in one embodiment of the present disclosure, each of the node objects represents a single vertex in the linked list.

Additionally, in one embodiment of the present disclosure, the method further comprises linking the node objects based on an attack vector.

Furthermore, in one embodiment of the present disclosure, the vulnerability characteristics used in assessing the security vulnerability's severity are retrieved from a data storage of a data lake which were processed and distributed from data sources contained within the data lake.

Additionally, in one embodiment of the present disclosure, the vulnerability characteristics used in assessing the security vulnerability's severity are retrieved from a data storage of a data lake using data storage indexes of the data lake.

Furthermore, in one embodiment of the present disclosure, the method additionally comprises parsing the list of CVEs associated with the multi-cloud environment.

Additionally, in one embodiment of the present disclosure, the method comprises mapping the retrieved vulnerability characteristics with the parsed list of CVEs associated with the multi-cloud environment to form the linked list.

Furthermore, in one embodiment of the present disclosure, the additionally comprises translating the mapping into the linked list.

Other forms of the embodiments of the computer-implemented method described above are in a system and in a computer program product.

Accordingly, embodiments of the present disclosure identify and prioritize vulnerability chains in a multi-cloud environment thereby enabling vulnerability attacks to be remediated and prevented across cloud platforms.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates a data lake storing large volumes of raw data directed to vulnerability characteristics used in assessing a security vulnerability's severity pertaining to common vulnerabilities and exposures (CVEs) in accordance with an embodiment of the present disclosure;

FIG. 3 illustrates an alternative embodiment of a data lake storing large volumes of raw data directed to vulnerability characteristics used in assessing a security vulnerability's severity pertaining to CVEs in accordance with an embodiment of the present disclosure;

FIG. 4 is a diagram of the software components used by the vulnerability chain identifier to identify and prioritize vulnerability chains in multi-cloud environments in accordance with an embodiment of the present disclosure;

FIG. 5 illustrates an embodiment of the present disclosure of the hardware configuration of the vulnerability chain identifier which is representative of a hardware environment for practicing the present disclosure; and

FIG. 6 is a flowchart of a method for identifying and prioritizing vulnerability chains in multi-cloud environments in accordance with an embodiment of the present disclosure.

### DETAILED DESCRIPTION

In one embodiment of the present disclosure, a computer-implemented method for identifying and prioritizing vulnerability chains in multi-cloud environments comprises receiving a list of common vulnerabilities and exposures (CVEs) associated with a multi-cloud environment. The method further comprises retrieving, for respective CVEs in the list of CVEs, vulnerability characteristics used in assessing a security vulnerability's severity. The method additionally comprises mapping the retrieved vulnerability characteristics with the list of CVEs associated with the multi-cloud environment to form a linked list. Furthermore, the method comprises identifying vulnerability chains in the multi-cloud environment from the linked list. Additionally, the method comprises generating priority scores for the identified vulnerability chains in the multi-cloud environment.

In this manner, vulnerability chains are identified and prioritized in a multi-cloud environment thereby enabling vulnerability attacks to be remediated and prevented across cloud platforms.

Furthermore, in one embodiment of the present disclosure, the vulnerability characteristics used in assessing the security vulnerability's severity comprise an asset cloud environment, an attack vector, a vulnerability threat score, a vulnerability attack complexity, and a vulnerability exploit weaponization.

In this manner, a security vulnerability's severity can be assessed.

Additionally, in one embodiment of the present disclosure, the method further comprises creating node objects from the mapping of the retrieved vulnerability characteristics with the list of CVEs associated with the multi-cloud environment.

In this manner, a more efficient and structured way to connect vulnerability information across different cloud environments is provided thereby enabling easier identification and remediation of vulnerabilities within a complex multi-cloud environment.

Furthermore, in one embodiment of the present disclosure, each of the node objects represents a single vertex in the linked list.

In this manner, a more efficient and structured way to connect vulnerability information across different cloud environments is provided thereby enabling easier identification and remediation of vulnerabilities within a complex multi-cloud environment.

Additionally, in one embodiment of the present disclosure, the method further comprises linking the node objects based on an attack vector.

In this manner, it can be determined how vulnerabilities interact between the cloud environments and could create vulnerability chains.

Furthermore, in one embodiment of the present disclosure, the vulnerability characteristics used in assessing the security vulnerability's severity are retrieved from a data storage of a data lake which were processed and distributed from data sources contained within the data lake.

In this manner, data sources in the data lake can be queried to retrieve vulnerability characteristics.

Additionally, in one embodiment of the present disclosure, the vulnerability characteristics used in assessing the security vulnerability's severity are retrieved from a data storage of a data lake using data storage indexes of the data lake.

In this manner, data sources in the data lake can be queried to retrieve vulnerability characteristics.

Furthermore, in one embodiment of the present disclosure, the method additionally comprises parsing the list of CVEs associated with the multi-cloud environment.

In this manner, a more efficient and structured way to connect vulnerability information across different cloud environments is provided thereby enabling easier identification and remediation of vulnerabilities within a complex multi-cloud environment.

Additionally, in one embodiment of the present disclosure, the method comprises mapping the retrieved vulnerability characteristics with the parsed list of CVEs associated with the multi-cloud environment to form the linked list.

In this manner, a more efficient and structured way to connect vulnerability information across different cloud environments is provided thereby enabling easier identification and remediation of vulnerabilities within a complex multi-cloud environment.

Furthermore, in one embodiment of the present disclosure, the additionally comprises translating the mapping into the linked list.

In this manner, a more efficient and structured way to connect vulnerability information across different cloud environments is provided thereby enabling easier identification and remediation of vulnerabilities within a complex multi-cloud environment.

Other forms of the embodiments of the computer-implemented method described above are in a system and in a computer program product.

As stated above, a vulnerability chain, also known as an exploit chain, is an attack method that combines multiple vulnerabilities to gain a greater level of compromise than a single vulnerability would allow. That is, a vulnerability chain is a combination of vulnerabilities, including low or medium rated vulnerabilities, that can create a critical attack against systems, especially when such systems are interconnected. For example, an exploitable vulnerability in one cloud environment could lead an attacker to gain access or escalate privileges across multiple cloud environments leading to massive data loss or system downtime.

Typically, cybersecurity attempts to identify and mitigate security vulnerabilities to prevent cyberattacks focus on a single cloud environment or require special connectivity between cloud accounts of multiple cloud environments which could actually increase risk across such cloud environments. For instance, the greater the interconnectivity between platforms, infrastructure, and applications, the higher the risk for attack techniques to be leveraged, such as injection attacks (inserting malicious code into a system through user input), disruption attacks (actions to overload or disable a system), or account compromise attacks (gaining access to a user's account credentials to gain unauthorized access to data or systems). For example, if a vulnerability was exploited in cloud environment A, and an attacker was able to leverage another vulnerability in cloud environment B to build a vulnerability chaining attack between the two cloud environments, they would be able to compromise two large cloud environments.

Unfortunately, there is not currently a means for effectively identifying vulnerability chains between cloud environments thereby making it impossible to remediate and prevent vulnerability attacks across cloud platforms. As a result, a significant cyber attack in a multi-cloud environment, such as a major data exfiltration (e.g., theft of sensitive data), ransomware (e.g., encrypts data and demands a ransom to decrypt it), and malware deployments (e.g., facilitates the data theft and potentially disrupts operations within the affected system), may occur. Such a significant cyber attack may result in disruption to systems impacting users and business revenue.

The embodiments of the present disclosure provide the means for identifying and prioritizing vulnerability chains in multi-cloud environments by mapping retrieved vulnerability characteristics used in assessing a security vulnerability's severity with a list of common vulnerabilities and exposures (CVEs) associated with the multi-cloud environment. Such a mapping is used to identify and assess the severity of security vulnerabilities within a multi-cloud environment. In one embodiment, such a mapping is translated into a linked list to enable a more efficient and structured way to connect vulnerability information across different cloud environments thereby enabling easier identification and remediation of vulnerabilities within a complex multi-cloud environment. In one embodiment, such a translation involves creating node objects from the mapping of the retrieved vulnerability characteristics used in assessing a security vulnerability's severity with the list of CVEs associated with the multi-cloud environment. In one embodiment, each node object represents a single vertex in the linked list. Furthermore, in one embodiment, the node objects are linked based on an attack vector (pathway or method that a hacker uses to gain unauthorized access to a computer system, network, or application) thereby determining how vulnerabilities interact between the cloud environments and could create vulnerability chains. Priority scores may then be generated for the respective vulnerability chains in the multi-cloud environment identified from the linked list. In one embodiment, such a score ranges from 0 to infinity, where the higher scores indicate higher priority. Vulnerabilities with higher scores should be remediated first, while those vulnerabilities with lower scores can be addressed after the higher priority vulnerabilities have been mitigated, such as via patches or upgrades. In this manner, vulnerability chains are identified and prioritized in a multi-cloud environment thereby enabling vulnerability attacks to be remediated and prevented across cloud platforms. These and other features will be discussed in further detail below.

In some embodiments of the present disclosure, the present disclosure comprises a computer-implemented method, system, and computer program product for identifying and prioritizing vulnerability chains in multi-cloud environments. In one embodiment of the present disclosure, a list of common vulnerabilities and exposures (CVEs) associated with a multi-cloud environment is received. A multi-cloud environment, as used herein, refers to the use of multiple public or private cloud services from different providers to build, operate, and secure applications. For example, a multi-cloud environment could include an organization using services from multiple cloud providers, such as AWS®, Microsoft® Azure®, and Google® Cloud Platform, allowing them to leverage the best features of each platform for different workloads. Common vulnerabilities and exposures (CVEs), as used herein, refer to a list of publicly disclosed computer security flaws. Furthermore, vulnerability characteristics used in assessing a security vulnerability's severity are retrieved for respective CVEs in the list of CVEs. Vulnerability characteristics, as used herein, refer to properties which are used for assessing the severity of a security vulnerability. Examples of vulnerability characteristics include, but are not limited to, an asset cloud environment, an attack vector, a vulnerability threat score, a vulnerability attack complexity, and a vulnerability exploit weaponization. Additionally, the retrieved vulnerability characteristics for the CVEs in the received list of CVEs are mapped with the list of CVEs associated with the multi-cloud environment to form a linked list. A linked list, as used herein, refers to a data structure that stores a sequence of nodes (also referred to herein as “node objects”), where each node contains data and a reference (pointer) to the next node in the sequence. Such a mapping is used to identify and assess the severity of security vulnerabilities within a multi-cloud environment thereby enabling the prioritization of remediation efforts by understanding the potential impact of each vulnerability based on its characteristics. That is, such mapping involves linking vulnerability characteristics to specific CVEs thereby leveraging information about the vulnerability's severity, exploitability, and potential impact. Furthermore, such mapping helps prioritize which vulnerabilities to be first addressed based on their potential risk and the severity of the associated CVE. Vulnerability chains in the multi-cloud environment are then identified from the linked list, such as by identifying node objects with corresponding vulnerability characteristics that include a local attack vector, identifying node objects with corresponding vulnerability characteristics that result in a privilege escalation, further credential dumping, or data enumeration, and identifying node objects with corresponding vulnerability characteristics that result in authenticated code execution, command injection, or file upload. Upon identifying such vulnerability chains in the multi-cloud environment from the linked list, the severity of potential maliciousness and risk of the identified vulnerability chain are assessed, such as via a “priority score.” In one embodiment, the maliciousness and risk of the identified vulnerability chain is identified based on a score corresponding to the X-Force threat score, which is a numerical rating assigned by the IBM® X-Force threat intelligence platform to assess the potential maliciousness and risk, where the higher score indicates a greater likelihood of a threat. Vulnerabilities with higher scores should be remediated first, while those vulnerabilities with lower scores can be addressed after the higher priority vulnerabilities have been mitigated, such as via patches or upgrades. In this manner, vulnerability chains are identified and prioritized in a multi-cloud environment thereby enabling vulnerability attacks to be remediated and prevented across cloud platforms.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

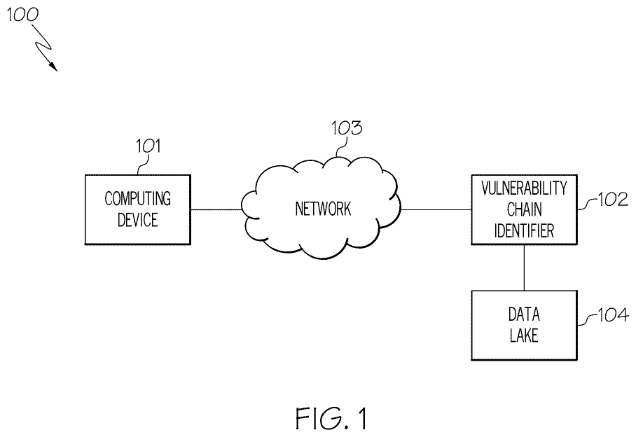

Referring now to the Figures in detail, FIG. 1 illustrates an embodiment of the present disclosure of a communication system 100 for practicing the principles of the present disclosure. Communication system 100 includes a computing device 101 connected to vulnerability chain identifier 102 via a network 103. Furthermore, as illustrated in FIG. 1, vulnerability chain identifier 102 is connected to a data lake 104.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and vulnerability chain identifier 102. It is noted that both computing device 101 and the user of computing device 101 may be identified with element number 101.

Network 103 may be, for example, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, the user of computing device 101 provides a list of common vulnerabilities and exposures (CVEs) associated with a multi-cloud environment to vulnerability chain identifier 102.

Common vulnerabilities and exposures (CVEs), as used herein, refer to a list of publicly disclosed computer security flaws. Such CVEs are assigned a CVE identification number, such as CVE-2017-0144 (Windows SMB flaw exploited by WannaCry ransomware), CVE-2021-34473 (ProxyShell vulnerabilities affecting Microsoft Exchange servers), etc. In one embodiment, the user of computing device 101 obtains such a list of CVEs associated with a multi-cloud environment, such as from a catalog or database storing such CVEs.

A multi-cloud environment, as used herein, refers to the use of multiple public or private cloud services from different providers to build, operate, and secure applications. For example, a multi-cloud environment could include an organization using services from multiple cloud providers, such as AWS®, Microsoft® Azure®, and Google® Cloud Platform, allowing them to leverage the best features of each platform for different workloads. For instance, an organization may utilize AWS® for email services and data analytics while using Google® Cloud for specific artificial intelligence tasks.

Vulnerability chain identifier 102 is configured to identify vulnerability chains in multi-cloud environments. A vulnerability chain, as used herein, is an attack method that combines multiple vulnerabilities to gain a greater level of compromise than a single vulnerability would allow. That is, a vulnerability chain is a combination of vulnerabilities, including low or medium rated vulnerabilities, that can create a critical attack against systems, especially when such systems are interconnected. For example, an exploitable vulnerability in one cloud environment could lead an attacker to gain access or escalate privileges across multiple cloud environments leading to massive data loss or system downtime.

In one embodiment, vulnerability chain identifier 102 identifies vulnerability chains in multi-cloud environments by retrieving vulnerability characteristics used in assessing a security vulnerability's severity, such as for the CVEs in the list of CVEs provided by the user of computing device 101. Vulnerability characteristics, as used herein, refer to properties which are used for assessing the severity of a security vulnerability. Examples of vulnerability characteristics include, but are not limited to, an asset cloud environment, an attack vector, a vulnerability threat score, a vulnerability attack complexity, and a vulnerability exploit weaponization.

In one embodiment, vulnerability chain identifier 102 retrieves such vulnerability characteristics from data lake 104. Data lake 104, as used herein, refers to a centralized repository that stores large volumes of raw data from various sources, including structured, semi-structured, and unstructured formats.

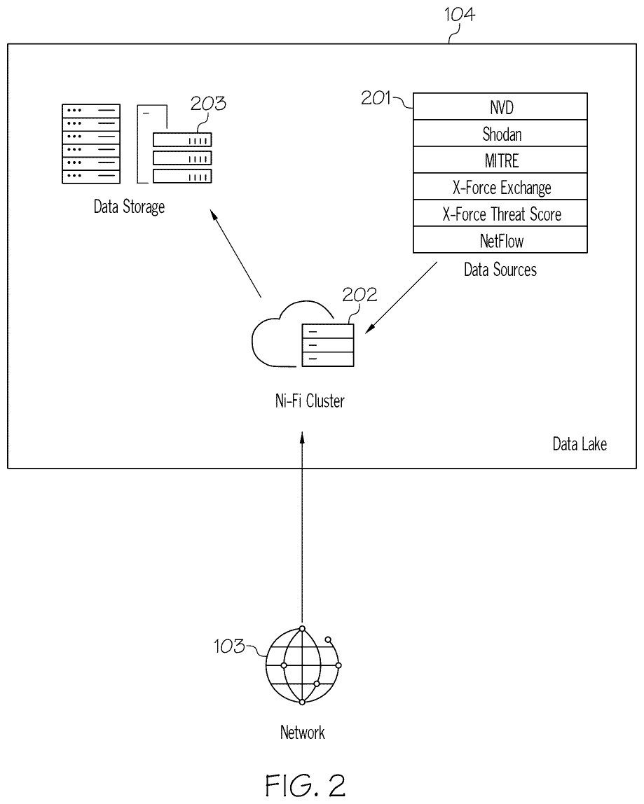

In one embodiment, vulnerability chain identifier 102 retrieves such vulnerability characteristics from data sources in data lake 104 as illustrated in FIG. 2.

FIG. 2 illustrates a data lake, such as data lake 104, storing large volumes of raw data directed to vulnerability characteristics used in assessing a security vulnerability's severity pertaining to CVEs in accordance with an embodiment of the present disclosure.

Referring to FIG. 2, in conjunction with FIG. 1, in one embodiment, data lake 104 includes a variety of data sources 201 storing vulnerability characteristics for specific CVEs. An example of such a data source 201 includes NVD (National Vulnerability Database), which is a U.S. government repository maintained by the National Institute of Standards and technology that contains detailed information about software and hardware vulnerabilities. Another example of data source 201 includes Shodan, which is a search engine that gathers information about Internet-connected devices by collecting metadata (“banners”) about the software running on a device. A further example of data source 201 includes MITRE, which refers to MITRE ATT&CK (Adversarial Tactics, Techniques, and Common Knowledge), which is a comprehensive matrix of tactics and techniques used by cyber adversaries. Another example of data source 201 includes X-Force Exchange, which refers to the IBM® X-Force Exchange, which is platform where security professionals can access and share threat intelligence data about malicious IP addresses, URLs, malware, and other potential threats, allowing them to research and assess the risk of various online entities. A further example of data source 201 is X-Force Threat Score, which is a data source provided by IBM® X-Force Exchange, which assigns a numerical score to an IP address or URL based on its potential maliciousness, indicating the likelihood of it being a threat, with a higher score representing a greater risk level. An additional example of data source 201 is NetFlow, which refers to network data, such as network usage patterns, source and destination IP addresses, packet counts, bytes transferred, etc.

In one embodiment, data lake 104 further includes Ni-Fi cluster 202. Ni-Fi cluster 202, as used herein, refers to a group of Apache® NiFi instances (open-source data ingestion platform) working together as a single system allowing for increased data processing throughput and improved fault tolerance by distributing the workload across several servers. In one embodiment, Ni-Fi cluster 202 is configured to process and distribute data from data sources 201 to data storage 203. That is, Ni-Fi cluster 202 performs data integration among the data from data sources 201, where such integrated data is processed and distributed to data storage 203. Such data stored in data storage 203, which includes vulnerability characteristics for specific CVEs, is retrieved by vulnerability chain identifier 102.

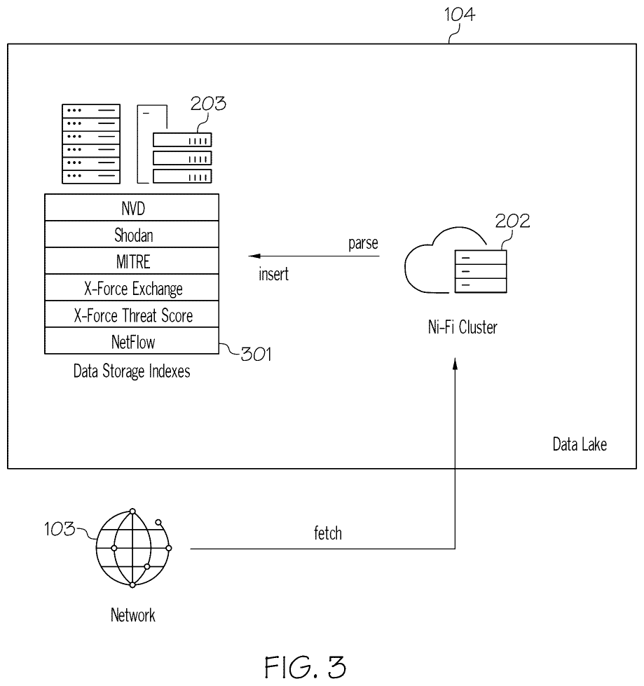

An alternative embodiment of data lake 104 is discussed below in connection with FIG. 3.

FIG. 3 illustrates an alternative embodiment of a data lake, such as data lake 104, storing large volumes of raw data directed to vulnerability characteristics used in assessing a security vulnerability's severity pertaining to CVEs in accordance with an embodiment of the present disclosure.

Referring to FIG. 3, in conjunction with FIG. 1, Ni-Fi cluster 202 of data lake 104 fetches vulnerability characteristics for specific CVEs, such as vulnerability characteristics stored in publicly external data sources accessible via network 103. For example, any of the data sources 201 discussed above in connection with FIG. 2 that are publicly available may also correspond to publicly external data sources, where vulnerability characteristics for specific CVEs stored in such publicly external data sources are fetched by Ni-Fi cluster 202.

In one embodiment, such data fetched by Ni-Fi cluster 202 is parsed and inserted in data storage 203, where the storage of such data is tracked by data storage indexes 301. For example, Ni-Fi cluster 202 may parse the fetched data based on the source of such fetched data, which includes NVD, Shodan, MITRE, X-Force Exchange, X-Force Scores, and NetFlow data sources as discussed above. Such parsed data is then inserted in data storage 203, where the storage of such data is tracked by data storage indexes 301. In one embodiment, data storage indexes 301, as used herein, refer to structured reference points that enable rapid access to relevant data without having to scan through the entire dataset.

Returning to FIG. 1, in conjunction with FIGS. 2-3, vulnerability chain identifier 102 maps the retrieved vulnerability characteristics for specific CVEs used in assessing a security vulnerability's severity with the list of common vulnerabilities and exposures (CVEs) associated with the multi-cloud environment. Such a mapping is used to identify and assess the severity of security vulnerabilities within a multi-cloud environment.

In one embodiment, vulnerability chain identifier 102 translates the mapping into a linked list to enable a more efficient and structured way to connect vulnerability information across different cloud environments thereby enabling easier identification and remediation of vulnerabilities within a complex multi-cloud environment. A linked list, as used herein, refers to a data structure that stores a sequence of nodes, where each node contains data and a reference (pointer) to the next node in the sequence. In one embodiment, in such a linked list, each node object represents a single vertex in the linked list. In one embodiment, such node objects are linked based on an attack vector (pathway or method that a hacker uses to gain unauthorized access to a computer system, network, or application) thereby determining how vulnerabilities interact between the cloud environments and could create vulnerability chains.

In one embodiment, vulnerability chain identifier 102 generates priority scores for the respective vulnerability chains in the multi-cloud environment identified from the linked list. In one embodiment, such a score ranges from 0 to infinity, where the higher scores indicate higher priority. Vulnerabilities with higher scores should be remediated first, while those vulnerabilities with lower scores can be addressed after the higher priority vulnerabilities have been mitigated, such as via patches or upgrades.

In this manner, vulnerability chains are identified and prioritized in a multi-cloud environment thereby enabling vulnerability attacks to be remediated and prevented across cloud platforms. These and other features will be discussed in further detail below.

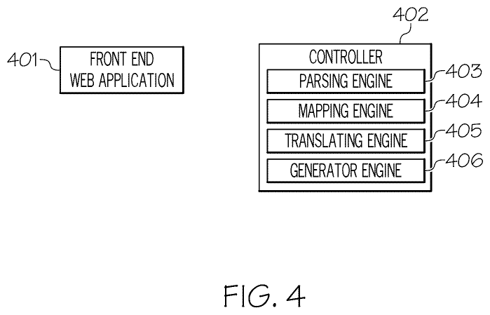

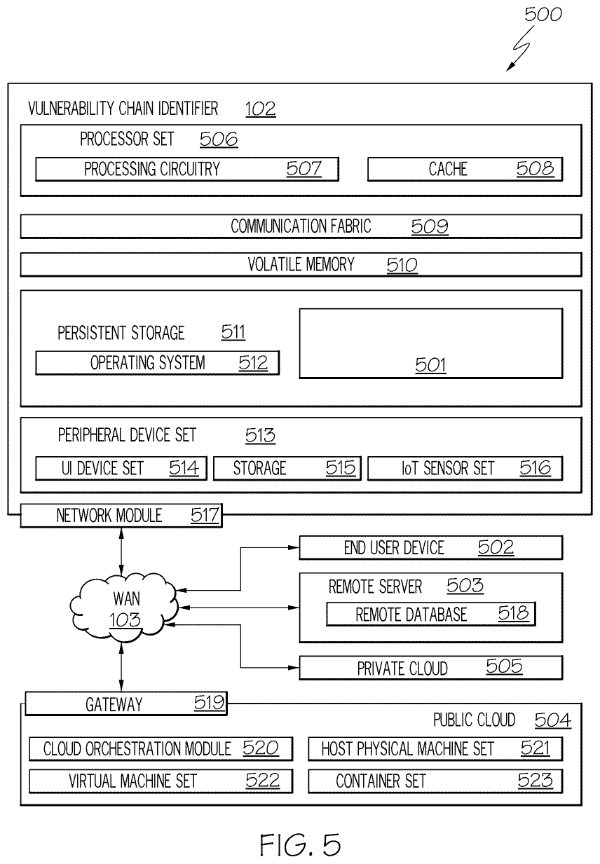

A description of the software components of vulnerability chain identifier 102 is provided below in connection with FIG. 4 and a description of the hardware configuration of vulnerability chain identifier 102 is provided further below in connection with FIG. 5.

System 100 is not to be limited in scope to any one particular network architecture. System 100 may include any number of computing devices 101, vulnerability chain identifiers 102, networks 103, and data lakes 104.

A discussion regarding the software components used by vulnerability chain identifier 102 to identify and prioritize vulnerability chains in multi-cloud environments is provided below in connection with FIG. 4.

FIG. 4 is a diagram of the software components used by vulnerability chain identifier 102 (FIG. 1) to identify and prioritize vulnerability chains in multi-cloud environments in accordance with an embodiment of the present disclosure.

Referring to FIG. 4, in conjunction with FIGS. 1-3, vulnerability chain identifier 102 includes a front end web application 401 configured to receive or ingest a list of common vulnerabilities and exposures (CVEs) associated with a multi-cloud environment.

A multi-cloud environment, as used herein, refers to the use of multiple public or private cloud services from different providers to build, operate, and secure applications. For example, a multi-cloud environment could include an organization using services from multiple cloud providers, such as AWS®, Microsoft® Azure®, and Google® Cloud Platform, allowing them to leverage the best features of each platform for different workloads. For instance, an organization may utilize AWS® for email services and data analytics while using Google® Cloud for specific artificial intelligence tasks.

In one embodiment, a list of CVEs associated with a multi-cloud environment is received by front end web application 401 from the user of computing device 101. Common vulnerabilities and exposures (CVEs), as used herein, refer to a list of publicly disclosed computer security flaws. Such CVEs are assigned a CVE identification number, such as CVE-2017-0144 (Windows SMB flaw exploited by WannaCry ransomware), CVE-2021-34473 (ProxyShell vulnerabilities affecting Microsoft Exchange servers), etc.

In one embodiment, front end web application 401 ingests the list of CVEs associated with a multi-cloud environment within a given specific file format (e.g., .csv, .json, .xml). The type of the file is then checked to ensure only permitted file types exist (e.g., application/csv, application/text, etc.).

In one embodiment, front end web application 401 provides input functionality for cases where the file uploads may not be applicable for smaller CVE entry uploads.

In one embodiment, front end web application 401 includes API (Application Programming Interface) connectivity for passing data to and from controller 402 of vulnerability chain identifier 102. For example, front end web application 401 is configured to pass the received list of CVEs associated with a multi-cloud environment to controller 402.

In one embodiment, examples of front end web application 401 that includes the functionality discussed above includes, but are not limited to, Burp Suite® Collaborator, Nmap® Web GUI, Nesses Web Interface, etc.

In one embodiment, controller 402 is configured to receive the list of CVEs from front end web application 401. In one embodiment, controller 402 including parsing engine 403 configured to parse the list of CVEs associated with the multi-cloud environment. Parsing, as used herein, is the process of analyzing the list of CVEs and separating the different CVEs that are listed in the list of CVEs. In one embodiment, such parsing is performed by identifying different CVE identification numbers and associating the description of the vulnerability, affected products, potential impact, and relevant references for that CVE identification number to such a CVE. In one embodiment, parsing engine 403 uses various software tools for such parsing, including, but are not limited to, Lido®, Parsehub, Nanonets, etc.

In one embodiment, controller 402 further includes mapping engine 404 configured to retrieve, for respective CVEs in the list of CVEs provided by front end web application 401, vulnerability characteristics used in assessing a security vulnerability's severity. Vulnerability characteristics, as used herein, refer to properties which are used for assessing the severity of a security vulnerability. Examples of vulnerability characteristics include, but are not limited to, an asset cloud environment, an attack vector, a vulnerability threat score, a vulnerability attack complexity, and a vulnerability exploit weaponization. An asset cloud environment, as used herein, refers to a digital storage system hosted on a cloud platform. An attack vector, as used herein, refers to a pathway or method that a hacker uses to gain unauthorized access to a system, including a cloud environment. A vulnerability threat score, as used herein, refers to a numerical value assigned to a cybersecurity vulnerability, such as using the common vulnerability scoring system (CVSS), which indicates the severity of the vulnerability, where a higher score signifies a more critical threat. A vulnerability attack complexity, as used herein, refers to the level of difficulty an attacker would face when trying to exploit a specific vulnerability thereby measuring how many conditions or steps are required to successfully launch an attack against it. A vulnerability exploit weaponization, as used herein, refers to the process of taking a known vulnerability in a system and actively developing it into a functional attack tool thereby transforming a potential weakness into a usable malicious exploit that can be deployed against a target system to gain unauthorized access or cause damage.

In one embodiment, mapping engine 404 retrieves such vulnerability characteristics for specific CVEs from data lake 104. For example, in one embodiment, mapping engine 404 retrieves such vulnerability characteristics for a specific CVE, such as a CVE listed in the received list of CVEs associated with a multi-cloud environment, from data storage 203 of data lake 104, which corresponds to the data that was processed and distributed by Ni-Fi cluster 202 from data sources 201. In one embodiment, mapping engine 404 retrieves such vulnerability characteristics for a specific CVE from data storage 203 of data lake 104 using data storage indexes 301 of data lake 104, which include structured reference points that enable rapid access to relevant data within data storage 203 without having to scan through the entire dataset of data storage 203.

Furthermore, in one embodiment, mapping engine 404 is configured to map the retrieved vulnerability characteristics for the CVEs in the received list of CVEs with the parsed list of common vulnerabilities and exposures (CVEs) associated with the multi-cloud environment. Such a mapping is used to identify and assess the severity of security vulnerabilities within a multi-cloud environment thereby enabling the prioritization of remediation efforts by understanding the potential impact of each vulnerability based on its characteristics.

In one embodiment, such mapping involves linking vulnerability characteristics to specific CVEs thereby leveraging information about the vulnerability's severity, exploitability, and potential impact. Furthermore, such mapping helps prioritize which vulnerabilities to be first addressed based on their potential risk and the severity of the associated CVE.

In one embodiment, mapping engine 404 performs such mapping by identifying common identifiers across the datasets (list of common vulnerabilities and exposures and the retrieved vulnerability characteristics). In one embodiment, such retrieved vulnerability characteristics are associated with a CVE. As a result, upon identifying a CVE listed in the provided list of CVEs, the vulnerability characteristics for such a CVE are then retrieved from data lake 104 and mapped to the identified CVE in the list of CVEs associated with a multi-cloud environment.

In one embodiment, mapping engine 404 utilizes various software tools to perform such mapping, including, but are not limited to, IBM® InfoSphere®, Informatica®, MuleSoft®, etc.

In one embodiment, controller 402 further includes a translating engine 405 configured to translate the mapping into a linked list to enable a more efficient and structured way to connect vulnerability information across different cloud environments thereby enabling easier identification and remediation of vulnerabilities within a complex multi-cloud environment. A linked list, as used herein, refers to a data structure that stores a sequence of nodes (also referred to herein as “node objects”), where each node contains data and a reference (pointer) to the next node in the sequence.

In one embodiment, in such a linked list, each node object represents a single vertex in the linked list. Such node objects are then linked based on an attack vector (pathway or method that a hacker uses to gain unauthorized access to a computer system, network, or application) thereby determining how vulnerabilities interact between the cloud environments and could create vulnerability chains.

For example, as discussed above, mapping engine 404 retrieves vulnerability characteristics for the respective CVEs in the received list of CVEs, which include an attack vector, which indicates whether a vulnerability can be exploited remotely (e.g., from a remote system) or locally (i.e., one must already have access to the vulnerable system). CVEs with a local attack vector that results in a security bypass or confidential exfiltration are likely a first link in the vulnerability chain as these vulnerabilities have a remote or adjacent attack vector used to establish an initial foothold on a given computing system. Hence, by translating engine 405 identifying node objects with corresponding vulnerability characteristics that include a local attack vector, such an identified node object corresponds to the first link of the vulnerability chains.

CVEs that result in a privilege escalation, further credential dumping, or data enumeration will serve as intermediate links in the vulnerability chain as they impact access confidentiality and integrity, and would elevate the privileges of a bad actor. As a result, translating engine 405 identifies node objects with such vulnerability characteristics as corresponding to the intermediate links in the vulnerability chains.

Furthermore, CVEs that result in authenticated code execution, command injection, or file upload will serve as the final link in the vulnerability chain. As a result, translating engine 405 identifies node objects with such vulnerability characteristics as corresponding to the final links in the vulnerability chains.

In one embodiment, translating engine 405 translates the mapping into a linked list using a data structure, where each node of the linked list represents a CVE and contains pointers to the corresponding vulnerability characteristics that are used to determine its severity.

In one embodiment, for each node that is created in the linked list, the node contains a CVE identifier. Furthermore, in one embodiment, each node contains a description, such as a brief summary of the CVE. Additionally, in one embodiment, each node contains pointers or references to the corresponding vulnerability characteristics associated with the CVE identified via the CVE identifier.

In one embodiment, translating engine 405 translates the mapping into a linked list by identifying the relevant vulnerability characteristics for each CVE based on analyzing the created node objects. Links are then established between the CVE node and the corresponding vulnerability characteristics (identified via the pointers or references of the CVE node). As a result, a network of relationships representing how the characteristics contribute to the overall CVE severity is established.

In one embodiment, translating engine 405 utilizes various software tools to perform such a translation of the mapping into a linked list as discussed above, including, but are not limited to, CloverETL, Pentaho Data Integration, Pimcore®, deque in Python from the collections module, the LinkedList class in C#, etc.

Additionally, in one embodiment, controller 402 includes a generator engine 406 configured to generate priority scores for respective vulnerability chains in the multi-cloud environment identified from the linked list.

In one embodiment, generator engine 406 identifies the vulnerability chains in the multi-cloud environment from the linked list, such as by identifying node objects with corresponding vulnerability characteristics that include a local attack vector, identifying node objects with corresponding vulnerability characteristics that result in a privilege escalation, further credential dumping, or data enumeration, and identifying node objects with corresponding vulnerability characteristics that result in authenticated code execution, command injection, or file upload. As previously discussed, by identifying such node objects in the linked list, vulnerability chains in the multi-cloud environment can be identified.

In one embodiment, generator engine 406 builds and trains a machine learning model to identify vulnerability chains in the multi-cloud environment from the linked list.

In one embodiment, generator engine 406 trains the machine learning model to identify vulnerability chains in the multi-cloud environment from the linked list based on a sample data set, which includes vulnerability chains in the multi-cloud environment that are identified from a linked list based on identifying node objects with vulnerability characteristics that include a local attack vector, identifying node objects with vulnerability characteristics that result in a privilege escalation, further credential dumping, or data enumeration, and identifying node objects with vulnerability characteristics that result in authenticated code execution, command injection, or file upload. In one embodiment, such a sample data set is populated by an expert.

Furthermore, in one embodiment, the sample data set discussed above is referred to herein as the “training data,” which is used by a machine learning algorithm to identify vulnerability chains in the multi-cloud environment from the linked list. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon identifying such vulnerability chains in the multi-cloud environment, the severity of potential maliciousness and risk of the identified vulnerability chain are assessed. In one embodiment, the maliciousness and risk of the identified vulnerability chain are identified based on a score corresponding to the X-Force threat score, which is a numerical rating assigned by the IBM® X-Force threat intelligence platform to assess the potential maliciousness and risk, where the higher score indicates a greater likelihood of a threat. In one embodiment, such a score ranges from 0 to 10. In another embodiment, such a score ranges from 0 to infinity.

In one embodiment, such X-Force threat scores associated with vulnerability chains in the multi-cloud environment are stored in a data structure (e.g., table). As a result, in one embodiment, generator engine 406 performs a search of such a data structure to identify an X-Force threat score based on the vulnerability chain identified from the linked list. In one embodiment, such a data structure is populated by an expert. In one embodiment, such a data structure resides within the storage device of vulnerability chain identifier 102.

In one embodiment, vulnerabilities with higher scores are remediated first, while those with lower scores can be addressed after the higher priority vulnerabilities have been mitigated through patching or upgrades.

In one embodiment, the priority scores generated for the respective vulnerability chains in the multi-cloud environment identified from the linked list are forwarded to front end web application 401 by generator engine 406, which provides such scores associated with the identified vulnerability chains in the multi-cloud environment to the user, such as the user of computing device 101. In such an embodiment, the user may proceed to address such identified vulnerability chains in the multi-cloud environment based on such priority scores.

In this manner, vulnerability chains are identified and prioritized in a multi-cloud environment thereby enabling vulnerability attacks to be remediated and prevented across cloud platforms.

A further description of these and other features is provided below in connection with the discussion of the method for identifying and prioritizing vulnerability chains in multi-cloud environments.

Prior to the discussion of the method for identifying and prioritizing vulnerability chains in multi-cloud environments, a description of the hardware configuration of vulnerability chain identifier 102 (FIG. 1) is provided below in connection with FIG. 5.

Referring now to FIG. 5, in conjunction with FIG. 1, FIG. 5 illustrates an embodiment of the present disclosure of the hardware configuration of vulnerability chain identifier 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the inventive methods, such as identifying and prioritizing vulnerability chains in multi-cloud environments. In addition to block 501, computing environment 500 includes, for example, vulnerability chain identifier 102, network 103, such as a wide area network (WAN), end user device (EUD) 502, remote server 503, public cloud 504, and private cloud 505. In this embodiment, vulnerability chain identifier 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Vulnerability chain identifier 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically vulnerability chain identifier 102, to keep the presentation as simple as possible. Vulnerability chain identifier 102 may be located in a cloud, even though it is not shown in a cloud in FIG. 5. On the other hand, vulnerability chain identifier 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto vulnerability chain identifier 102 to cause a series of operational steps to be performed by processor set 506 of vulnerability chain identifier 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of vulnerability chain identifier 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In vulnerability chain identifier 102, the volatile memory 510 is located in a single package and is internal to vulnerability chain identifier 102, but, alternatively or additionally, the volatile memory may be distributed over multiple packages and/or located externally with respect to vulnerability chain identifier 102.

Persistent Storage 511 is any form of non-volatile storage for computers that is now known or to be developed in the future. The non-volatility of this storage means that the stored data is maintained regardless of whether power is being supplied to vulnerability chain identifier 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of vulnerability chain identifier 102. Data communication connections between the peripheral devices and the other components of vulnerability chain identifier 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where vulnerability chain identifier 102 is required to have a large amount of storage (for example, where vulnerability chain identifier 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows vulnerability chain identifier 102 to communicate with other computers through WAN 103. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to vulnerability chain identifier 102 from an external computer or external storage device through a network adapter card or network interface included in network module 517.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates vulnerability chain identifier 102), and may take any of the forms discussed above in connection with vulnerability chain identifier 102. EUD 502 typically receives helpful and useful data from the operations of vulnerability chain identifier 102. For example, in a hypothetical case where vulnerability chain identifier 102 is designed to provide a recommendation to an end user, this recommendation would typically be communicated from network module 517 of vulnerability chain identifier 102 through WAN 103 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to vulnerability chain identifier 102. Remote server 503 may be controlled and used by the same entity that operates vulnerability chain identifier 102. Remote server 503 represents the machine(s) that collect and store helpful and useful data for use by other computers, such as vulnerability chain identifier 102. For example, in a hypothetical case where vulnerability chain identifier 102 is designed and programmed to provide a recommendation based on historical data, then this historical data may be provided to vulnerability chain identifier 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIG. 5 to identify and prioritize vulnerability chains in multi-cloud environments. In one embodiment, such components may be implemented in hardware. The functions discussed above performed by such components are not generic computer functions. As a result, vulnerability chain identifier 102 is a particular machine that is the result of implementing specific, non-generic computer functions.

In one embodiment, the functionality of such software components of vulnerability chain identifier 102, including the functionality for identifying and prioritizing vulnerability chains in multi-cloud environments, may be embodied in an application specific integrated circuit.

As stated above, a vulnerability chain, also known as an exploit chain, is an attack method that combines multiple vulnerabilities to gain a greater level of compromise than a single vulnerability would allow. That is, a vulnerability chain is a combination of vulnerabilities, including low or medium rated vulnerabilities, that can create a critical attack against systems, especially when such systems are interconnected. For example, an exploitable vulnerability in one cloud environment could lead an attacker to gain access or escalate privileges across multiple cloud environments leading to massive data loss or system downtime. Typically, cybersecurity attempts to identify and mitigate security vulnerabilities to prevent cyberattacks focus on a single cloud environment or require special connectivity between cloud accounts of multiple cloud environments which could actually increase risk across such cloud environments. For instance, the greater the interconnectivity between platforms, infrastructure, and applications, the higher the risk for attack techniques to be leveraged, such as injection attacks (inserting malicious code into a system through user input), disruption attacks (actions to overload or disable a system), or account compromise attacks (gaining access to a user's account credentials to gain unauthorized access to data or systems). For example, if a vulnerability was exploited in cloud environment A, and an attacker was able to leverage another vulnerability in cloud environment B to build a vulnerability chaining attack between the two cloud environments, they would be able to compromise two large cloud environments. Unfortunately, there is not currently a means for effectively identifying vulnerability chains between cloud environments thereby making it impossible to remediate and prevent vulnerability attacks across cloud platforms. As a result, a significant cyber attack in a multi-cloud environment, such as a major data exfiltration (e.g., theft of sensitive data), ransomware (e.g., encrypts data and demands a ransom to decrypt it), and malware deployments (e.g., facilitates the data theft and potentially disrupts operations within the affected system), may occur. Such a significant cyber attack may result in disruption to systems impacting users and business revenue.

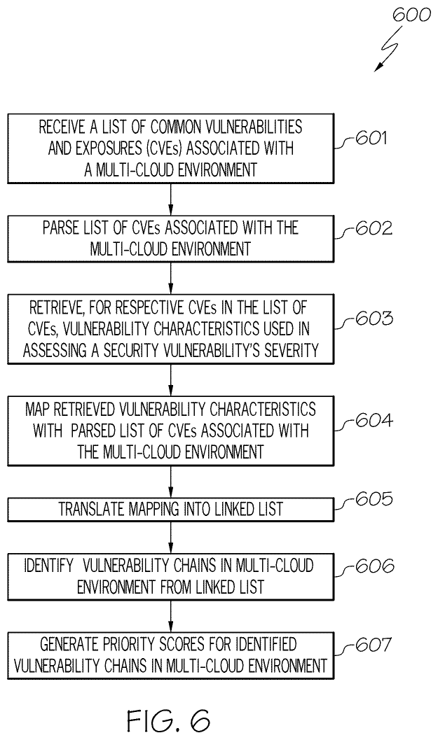

The embodiments of the present disclosure provide a means for identifying and prioritizing vulnerability chains in multi-cloud environments as discussed below in connection with FIG. 6.

FIG. 6 is a flowchart of a method 600 for identifying and prioritizing vulnerability chains in multi-cloud environments in accordance with an embodiment of the present disclosure.

Referring to FIG. 6, in conjunction with FIGS. 1-5, in step 601, front end web application 401 of vulnerability chain identifier 102 receives or ingests a list of common vulnerabilities and exposures (CVEs) associated with a multi-cloud environment.

As discussed above, a multi-cloud environment, as used herein, refers to the use of multiple public or private cloud services from different providers to build, operate, and secure applications. For example, a multi-cloud environment could include an organization using services from multiple cloud providers, such as AWS®, Microsoft® Azure®, and Google® Cloud Platform, allowing them to leverage the best features of each platform for different workloads. For instance, an organization may utilize AWS® for email services and data analytics while using Google® Cloud for specific artificial intelligence tasks.

In one embodiment, a list of CVEs associated with a multi-cloud environment is received by front end web application 401 from the user of computing device 101. Common vulnerabilities and exposures (CVEs), as used herein, refer to a list of publicly disclosed computer security flaws. Such CVEs are assigned a CVE identification number, such as CVE-2017-0144 (Windows SMB flaw exploited by WannaCry ransomware), CVE-2021-34473 (ProxyShell vulnerabilities affecting Microsoft Exchange servers), etc.

In one embodiment, front end web application 401 ingests the list of CVEs associated with a multi-cloud environment within a given specific file format (e.g., .csv, .json, .xml). The type of the file is then checked to ensure only permitted file types exist (e.g., application/csv, application/text, etc.).

In one embodiment, front end web application 401 provides input functionality for cases where the file uploads may not be applicable for smaller CVE entry uploads.

In one embodiment, front end web application 401 includes API (Application Programming Interface) connectivity for passing data to and from controller 402 of vulnerability chain identifier 102. For example, front end web application 401 is configured to pass the received list of CVEs associated with a multi-cloud environment to controller 402.

In one embodiment, examples of front end web application 401 that includes the functionality discussed above includes, but are not limited to, Burp Suite® Collaborator, Nmap® Web GUI, Nesses Web Interface, etc.

In step 602, parsing engine 403 of controller 402 parses the list of CVEs associated with the multi-cloud environment, which was received from front end web application 401.

As stated above, parsing, as used herein, is the process of analyzing the list of CVEs and separating the different CVEs that are listed in the list of CVEs. In one embodiment, such parsing is performed by identifying different CVE identification numbers and associating the description of the vulnerability, affected products, potential impact, and relevant references for that CVE identification number to such a CVE. In one embodiment, parsing engine 403 uses various software tools for such parsing, including, but are not limited to, Lido®, Parsehub, Nanonets, etc.

In step 603, mapping engine 404 of controller 402 retrieves, for respective CVEs in the list of CVEs provided by front end web application 401, vulnerability characteristics used in assessing a security vulnerability's severity.

As discussed above, vulnerability characteristics, as used herein, refer to properties which are used for assessing the severity of a security vulnerability. Examples of vulnerability characteristics include, but are not limited to, an asset cloud environment, an attack vector, a vulnerability threat score, a vulnerability attack complexity, and a vulnerability exploit weaponization. An asset cloud environment, as used herein, refers to a digital storage system hosted on a cloud platform. An attack vector, as used herein, refers to a pathway or method that a hacker uses to gain unauthorized access to a system, including a cloud environment. A vulnerability threat score, as used herein, refers to a numerical value assigned to a cybersecurity vulnerability, such as using the common vulnerability scoring system (CVSS), which indicates the severity of the vulnerability, where a higher score signifies a more critical threat. A vulnerability attack complexity, as used herein, refers to the level of difficulty an attacker would face when trying to exploit a specific vulnerability thereby measuring how many conditions or steps are required to successfully launch an attack against it. A vulnerability exploit weaponization, as used herein, refers to the process of taking a known vulnerability in a system and actively developing it into a functional attack tool thereby transforming a potential weakness into a usable malicious exploit that can be deployed against a target system to gain unauthorized access or cause damage.

In one embodiment, mapping engine 404 retrieves such vulnerability characteristics for specific CVEs from data lake 104. For example, in one embodiment, mapping engine 404 retrieves such vulnerability characteristics for a specific CVE, such as a CVE listed in the received list of CVEs associated with a multi-cloud environment, from data storage 203 of data lake 104, which corresponds to the data that was processed and distributed by Ni-Fi cluster 202 from data sources 201. In one embodiment, mapping engine 404 retrieves such vulnerability characteristics for a specific CVE from data storage 203 of data lake 104 using data storage indexes 301 of data lake 104, which include structured reference points that enable rapid access to relevant data within data storage 203 without having to scan through the entire dataset of data storage 203.

In step 604, mapping engine 404 of controller 402 maps the retrieved vulnerability characteristics for the CVEs in the received list of CVEs with the parsed list of common vulnerabilities and exposures (CVEs) associated with the multi-cloud environment. Such a mapping is used to identify and assess the severity of security vulnerabilities within a multi-cloud environment thereby enabling the prioritization of remediation efforts by understanding the potential impact of each vulnerability based on its characteristics.

As stated above, in one embodiment, such mapping involves linking vulnerability characteristics to specific CVEs thereby leveraging information about the vulnerability's severity, exploitability, and potential impact. Furthermore, such mapping helps prioritize which vulnerabilities to be first addressed based on their potential risk and the severity of the associated CVE.

In one embodiment, mapping engine 404 performs such mapping by identifying common identifiers across the datasets (list of common vulnerabilities and exposures and the retrieved vulnerability characteristics). In one embodiment, such retrieved vulnerability characteristics are associated with a CVE. As a result, upon identifying a CVE listed in the provided list of CVEs, the vulnerability characteristics for such a CVE are then retrieved from data lake 104 and mapped to the identified CVE in the list of CVEs associated with a multi-cloud environment.

In one embodiment, mapping engine 404 utilizes various software tools to perform such mapping, including, but are not limited to, IBM® InfoSphere®, Informatica®, MuleSoft®, etc.

In step 605, translating engine 405 of controller 402 translates the mapping into a linked list to enable a more efficient and structured way to connect vulnerability information across different cloud environments thereby enabling easier identification and remediation of vulnerabilities within a complex multi-cloud environment.

As stated above, a linked list, as used herein, refers to a data structure that stores a sequence of nodes (also referred to herein as “node objects”), where each node contains data and a reference (pointer) to the next node in the sequence.

In one embodiment, in such a linked list, each node object represents a single vertex in the linked list. In one embodiment, such node objects are linked based on an attack vector (pathway or method that a hacker uses to gain unauthorized access to a computer system, network, or application) thereby determining how vulnerabilities interact between the cloud environments and could create vulnerability chains.

For example, as discussed above, mapping engine 404 retrieves vulnerability characteristics for the respective CVEs in the received list of CVEs, which include an attack vector, which indicates whether a vulnerability can be exploited remotely (e.g., from a remote system) or locally (i.e., one must already have access to the vulnerable system). CVEs with a local attack vector that results in a security bypass or confidential exfiltration are likely a first link in the vulnerability chain as these vulnerabilities have a remote or adjacent attack vector used to establish an initial foothold on a given computing system. Hence, by translating engine 405 identifying node objects with corresponding vulnerability characteristics that include a local attack vector, such an identified node object corresponds to the first link of the vulnerability chains.

CVEs that result in a privilege escalation, further credential dumping, or data enumeration will serve as intermediate links in the vulnerability chain as they impact access confidentiality and integrity, and would elevate the privileges of a bad actor. As a result, translating engine 405 identifies node objects with such vulnerability characteristics as corresponding to the intermediate links in the vulnerability chains.

Furthermore, CVEs that result in authenticated code execution, command injection, or file upload will serve as the final link in the vulnerability chain. As a result, translating engine 405 identifies node objects with such vulnerability characteristics as corresponding to the final links in the vulnerability chains.

In one embodiment, translating engine 405 translates the mapping into a linked list using a data structure, where each node of the linked list represents a CVE and contains pointers to the corresponding vulnerability characteristics that are used to determine its severity.

In one embodiment, for each node that is created in the linked list, the node contains a CVE identifier. Furthermore, in one embodiment, each node contains a description, such as a brief summary of the CVE. Additionally, in one embodiment, each node contains pointers or references to the corresponding vulnerability characteristics associated with the CVE identified via the CVE identifier.

In one embodiment, translating engine 405 translates the mapping into a linked list by identifying the relevant vulnerability characteristics for each CVE based on analyzing the created node objects. Links are then established between the CVE node and the corresponding vulnerability characteristics (identified via the pointers or references of the CVE node). As a result, a network of relationships representing how the characteristics contribute to the overall CVE severity is established.

In one embodiment, translating engine 405 utilizes various software tools to perform such a translation of the mapping into a linked list as discussed above, including, but are not limited to, CloverETL, Pentaho Data Integration, Pimcore®, deque in Python from the collections module, the LinkedList class in C#, etc.

In step 606, generator engine 406 of controller 402 identifies the vulnerability chains in the multi-cloud environment from the linked list, such as by identifying node objects with vulnerability characteristics that include a local attack vector, identifying node objects with vulnerability characteristics that result in a privilege escalation, further credential dumping, or data enumeration, and identifying node objects with corresponding vulnerability characteristics that result in authenticated code execution, command injection, or file upload. As previously discussed, by identifying such node objects in the linked list, vulnerability chains in the multi-cloud environment can be identified.

In one embodiment, generator engine 406 builds and trains a machine learning model to identify vulnerability chains in the multi-cloud environment from the linked list.

In one embodiment, generator engine 406 trains the machine learning model to identify vulnerability chains in the multi-cloud environment from the linked list based on a sample data set, which includes vulnerability chains in the multi-cloud environment that are identified from a linked list based on identifying node objects with vulnerability characteristics that include a local attack vector, identifying node objects with vulnerability characteristics that result in a privilege escalation, further credential dumping, or data enumeration, and identifying node objects with vulnerability characteristics that result in authenticated code execution, command injection, or file upload. In one embodiment, such a sample data set is populated by an expert.

Furthermore, in one embodiment, the sample data set discussed above is referred to herein as the “training data,” which is used by a machine learning algorithm to identify vulnerability chains in the multi-cloud environment from the linked list. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

In step 607, upon identifying such vulnerability chains in the multi-cloud environment, generator engine 406 of controller 402 generates priority scores for the identified vulnerability chains in the multi-cloud environment in order to assess the severity of potential maliciousness and risk of the identified vulnerability chain.

As discussed above, in one embodiment, the maliciousness and risk of the identified vulnerability chain are identified based on a score corresponding to the X-Force threat score, which is a numerical rating assigned by the IBM® X-Force threat intelligence platform to assess the potential maliciousness and risk, where the higher score indicates a greater likelihood of a threat. In one embodiment, such a score ranges from 0 to 10. In another embodiment, such a score ranges from 0 to infinity.

In one embodiment, such X-Force threat scores associated with vulnerability chains in the multi-cloud environment are stored in a data structure (e.g., table). As a result, in one embodiment, generator engine 406 performs a search of such a data structure to identify an X-Force threat score based on the vulnerability chain identified from the linked list. In one embodiment, such a data structure is populated by an expert. In one embodiment, such a data structure resides within the storage device (e.g., storage device 511, 515) of vulnerability chain identifier 102.

In one embodiment, vulnerabilities with higher scores are remediated first, while those with lower scores can be addressed after the higher priority vulnerabilities have been mitigated through patching or upgrades.

In one embodiment, the priority scores generated for the respective vulnerability chains in the multi-cloud environment identified from the linked list are forwarded to front end web application 401 by generator engine 406, which provides such scores associated with the identified vulnerability chains in the multi-cloud environment to the user, such as the user of computing device 101. In such an embodiment, the user may proceed to address such identified vulnerability chains in the multi-cloud environment based on such priority scores.

In this manner, vulnerability chains are identified and prioritized in a multi-cloud environment thereby enabling vulnerability attacks to be remediated and prevented across cloud platforms.

Furthermore, the principles of the present disclosure improve the technology or technical field involving cybersecurity.

As discussed above, a vulnerability chain, also known as an exploit chain, is an attack method that combines multiple vulnerabilities to gain a greater level of compromise than a single vulnerability would allow. That is, a vulnerability chain is a combination of vulnerabilities, including low or medium rated vulnerabilities, that can create a critical attack against systems, especially when such systems are interconnected. For example, an exploitable vulnerability in one cloud environment could lead an attacker to gain access or escalate privileges across multiple cloud environments leading to massive data loss or system downtime. Typically, cybersecurity attempts to identify and mitigate security vulnerabilities to prevent cyberattacks focus on a single cloud environment or require special connectivity between cloud accounts of multiple cloud environments which could actually increase risk across such cloud environments. For instance, the greater the interconnectivity between platforms, infrastructure, and applications, the higher the risk for attack techniques to be leveraged, such as injection attacks (inserting malicious code into a system through user input), disruption attacks (actions to overload or disable a system), or account compromise attacks (gaining access to a user's account credentials to gain unauthorized access to data or systems). For example, if a vulnerability was exploited in cloud environment A, and an attacker was able to leverage another vulnerability in cloud environment B to build a vulnerability chaining attack between the two cloud environments, they would be able to compromise two large cloud environments. Unfortunately, there is not currently a means for effectively identifying vulnerability chains between cloud environments thereby making it impossible to remediate and prevent vulnerability attacks across cloud platforms. As a result, a significant cyber attack in a multi-cloud environment, such as a major data exfiltration (e.g., theft of sensitive data), ransomware (e.g., encrypts data and demands a ransom to decrypt it), and malware deployments (e.g., facilitates the data theft and potentially disrupts operations within the affected system), may occur. Such a significant cyber attack may result in disruption to systems impacting users and business revenue.

Embodiments of the present disclosure improve such technology by receiving a list of common vulnerabilities and exposures (CVEs) associated with a multi-cloud environment. A multi-cloud environment, as used herein, refers to the use of multiple public or private cloud services from different providers to build, operate, and secure applications. For example, a multi-cloud environment could include an organization using services from multiple cloud providers, such as AWS®, Microsoft® Azure®, and Google® Cloud Platform, allowing them to leverage the best features of each platform for different workloads. Common vulnerabilities and exposures (CVEs), as used herein, refer to a list of publicly disclosed computer security flaws. Furthermore, vulnerability characteristics used in assessing a security vulnerability's severity are retrieved for respective CVEs in the list of CVEs. Vulnerability characteristics, as used herein, refer to properties which are used for assessing the severity of a security vulnerability. Examples of vulnerability characteristics include, but are not limited to, an asset cloud environment, an attack vector, a vulnerability threat score, a vulnerability attack complexity, and a vulnerability exploit weaponization. Additionally, the retrieved vulnerability characteristics for the CVEs in the received list of CVEs are mapped with the list of CVEs associated with the multi-cloud environment to form a linked list. A linked list, as used herein, refers to a data structure that stores a sequence of nodes (also referred to herein as “node objects”), where each node contains data and a reference (pointer) to the next node in the sequence. Such a mapping is used to identify and assess the severity of security vulnerabilities within a multi-cloud environment thereby enabling the prioritization of remediation efforts by understanding the potential impact of each vulnerability based on its characteristics. That is, such mapping involves linking vulnerability characteristics to specific CVEs thereby leveraging information about the vulnerability's severity, exploitability, and potential impact. Furthermore, such mapping helps prioritize which vulnerabilities to be first addressed based on their potential risk and the severity of the associated CVE. Vulnerability chains in the multi-cloud environment are then identified from the linked list, such as by identifying node objects with corresponding vulnerability characteristics that include a local attack vector, identifying node objects with corresponding vulnerability characteristics that result in a privilege escalation, further credential dumping, or data enumeration, and identifying node objects with corresponding vulnerability characteristics that result in authenticated code execution, command injection, or file upload. Upon identifying such vulnerability chains in the multi-cloud environment from the linked list, the severity of potential maliciousness and risk of the identified vulnerability chain are assessed, such as via a “priority score.” In one embodiment, the maliciousness and risk of the identified vulnerability chain is identified based on a score corresponding to the X-Force threat score, which is a numerical rating assigned by the IBM® X-Force threat intelligence platform to assess the potential maliciousness and risk, where the higher score indicates a greater likelihood of a threat. Vulnerabilities with higher scores should be remediated first, while those vulnerabilities with lower scores can be addressed after the higher priority vulnerabilities have been mitigated, such as via patches or upgrades. In this manner, vulnerability chains are identified and prioritized in a multi-cloud environment thereby enabling vulnerability attacks to be remediated and prevented across cloud platforms. Furthermore, in this manner, there is an improvement in the technical field involving cybersecurity.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for identifying and prioritizing vulnerability chains in multi-cloud environments, the method comprising:
receiving a list of common vulnerabilities and exposures (CVEs) associated with a multi-cloud environment;
retrieving, for respective CVEs in said list of CVEs, vulnerability characteristics used in assessing a security vulnerability's severity;
mapping said retrieved vulnerability characteristics with said list of CVEs associated with said multi-cloud environment to form a linked list;
identifying vulnerability chains in said multi-cloud environment from said linked list; and
generating priority scores for said identified vulnerability chains in said multi-cloud environment.

2. The method as recited in claim 1, wherein said vulnerability characteristics used in assessing said security vulnerability's severity comprise an asset cloud environment, an attack vector, a vulnerability threat score, a vulnerability attack complexity, and a vulnerability exploit weaponization.

3. The method as recited in claim 1 further comprising:
creating node objects from said mapping of said retrieved vulnerability characteristics with said list of CVEs associated with said multi-cloud environment.

4. The method as recited in claim 3, wherein each of said node objects represents a single vertex in said linked list.

5. The method as recited in claim 4 further comprising:
linking said node objects based on an attack vector.

6. The method as recited in claim 1, wherein said vulnerability characteristics used in assessing said security vulnerability's severity are retrieved from a data storage of a data lake which were processed and distributed from data sources contained within said data lake.

7. The method as recited in claim 1, wherein said vulnerability characteristics used in assessing said security vulnerability's severity are retrieved from a data storage of a data lake using data storage indexes of said data lake.

8. The method as recited in claim 1 further comprising:
parsing said list of CVEs associated with said multi-cloud environment.

9. The method as recited in claim 8 further comprising:
mapping said retrieved vulnerability characteristics with said parsed list of CVEs associated with said multi-cloud environment to form said linked list.

10. The method as recited in claim 9 further comprising:
translating said mapping into said linked list.

11. A computer program product for identifying and prioritizing vulnerability chains in multi-cloud environments, the computer program product comprising one or more computer readable storage mediums having program code embodied therewith, the program code comprising programming instructions for:
receiving a list of common vulnerabilities and exposures (CVEs) associated with a multi-cloud environment;
retrieving, for respective CVEs in said list of CVEs, vulnerability characteristics used in assessing a security vulnerability's severity;
mapping said retrieved vulnerability characteristics with said list of CVEs associated with said multi-cloud environment to form a linked list;
identifying vulnerability chains in said multi-cloud environment from said linked list; and
generating priority scores for said identified vulnerability chains in said multi-cloud environment.

12. The computer program product as recited in claim 11, wherein said vulnerability characteristics used in assessing said security vulnerability's severity comprise an asset cloud environment, an attack vector, a vulnerability threat score, a vulnerability attack complexity, and a vulnerability exploit weaponization.

13. The computer program product as recited in claim 11, wherein the program code further comprises the programming instructions for:
creating node objects from said mapping of said retrieved vulnerability characteristics with said list of CVEs associated with said multi-cloud environment.

14. The computer program product as recited in claim 13, wherein each of said node objects represents a single vertex in said linked list.

15. The computer program product as recited in claim 14, wherein the program code further comprises the programming instructions for:
linking said node objects based on an attack vector.

16. The computer program product as recited in claim 11, wherein said vulnerability characteristics used in assessing said security vulnerability's severity are retrieved from a data storage of a data lake which were processed and distributed from data sources contained within said data lake.

17. The computer program product as recited in claim 11, wherein said vulnerability characteristics used in assessing said security vulnerability's severity are retrieved from a data storage of a data lake using data storage indexes of said data lake.

18. The computer program product as recited in claim 11, wherein the program code further comprises the programming instructions for:
parsing said list of CVEs associated with said multi-cloud environment.

19. The computer program product as recited in claim 18, wherein the program code further comprises the programming instructions for:
mapping said retrieved vulnerability characteristics with said parsed list of CVEs associated with said multi-cloud environment to form said linked list.

20. The computer program product as recited in claim 19, wherein the program code further comprises the programming instructions for:
translating said mapping into said linked list.

21. A system, comprising:
a memory for storing a computer program for identifying and prioritizing vulnerability chains in multi-cloud environments; and
a processor connected to the memory, wherein the processor is configured to execute program instructions of the computer program comprising:
receiving a list of common vulnerabilities and exposures (CVEs) associated with a multi-cloud environment;
retrieving, for respective CVEs in said list of CVEs, vulnerability characteristics used in assessing a security vulnerability's severity;
mapping said retrieved vulnerability characteristics with said list of CVEs associated with said multi-cloud environment to form a linked list;
identifying vulnerability chains in said multi-cloud environment from said linked list; and
generating priority scores for said identified vulnerability chains in said multi-cloud environment.

22. The system as recited in claim 21, wherein said vulnerability characteristics used in assessing said security vulnerability's severity comprise an asset cloud environment, an attack vector, a vulnerability threat score, a vulnerability attack complexity, and a vulnerability exploit weaponization.

23. The system as recited in claim 21, wherein the program instructions of the computer program further comprise:
creating node objects from said mapping of said retrieved vulnerability characteristics with said list of CVEs associated with said multi-cloud environment.

24. The system as recited in claim 23, wherein each of said node objects represents a single vertex in said linked list.

25. The system as recited in claim 24, wherein the program instructions of the computer program further comprise:
linking said node objects based on an attack vector.
